(19) United States
(12) Patent Application Publication
(10) Pub. No.: US 2018/0012299 A1
(43) Pub. Date: Jan. 11, 2018

(54) SYSTEM AND METHODS FOR EXTENDING CREDIT LINES ASSOCIATED WITH CREDIT RATINGS

(71) Applicant: Lantern Credit, LLC, Newport Beach, CA (US)

(72) Inventor: William B. Harvey, Irvine, CA (US)

(21) Appl. No.: 15/647,030

(22) Filed: Jul. 11, 2017

Related U.S. Application Data
(60) Provisional application No. 62/360,824, filed on Jul. 11, 2016.

(51) Int. Cl. G06Q 40/02; G06Q 20/24

(52) U.S. Cl. CPC G06Q 40/025; G06Q 20/24

(57) ABSTRACT

Methods and systems for extending credit associated with credit ratings are disclosed. One or more credit scores of a person may he received and, if the credit scores are insufficient to qualify the person for a credit line from a lender, the lender may inform the person what actions can be undertaken to improve the credit scores. Once completed, the lender may then extend a credit line to the person. Alternatively, a lender may receive a first credit score of a person and determine the actions to be undertaken in order to improve the credit score to a second credit score. Pre-determined time periods for completion may he established. The lender may determine different credit lines based upon different credit scores and extend a credit line to the person or upgrade/downgrade the credit line if certain actions are completed or not completed.

### CROSS REFERENCE TO RELATED APPLICATIONS

This application claims the benefit of U.S. Provisional Patent Application Ser. No. 62/360,824, filed on Jul. 11, 2016, entitled “METHODS FOR EXTENDING CREDIT LINES ASSOCIATED WITH CREDIT RATINGS,” which is hereby incorporated by reference in its entirety.

### BACKGROUND

### 1. Field of the Invention

The invention relates to methods and systems for extending credit lines associated with credit ratings. More particularly, the invention relates to methods and systems for providing multiple financial offers or solutions to consumers at various credit ratings levels and associated functionality.

### 2. Description of the Related Art

Obtaining credit lines from lenders is important for most consumers. Lenders extend credit lines to consumers based on consumers' credit ratings (e.g., credit scores) for instance through issuing credit cards with credit lines. A particular consumer's credit score is determined based on the consumer's credit history. Credit rating institutions provide consumers' credit ratings to lenders upon request. Consumers with undesirable credit history will have their credit scores fall within a credit score range where lenders tend to decline extending credit lines to those consumers. Unfortunately, these consumers, for instance consumers with non-existent or little credit history or those who have experienced or are experiencing financial difficulties, are those who may need credit lines the most. Therefore, it is important to encourage or assist those consumers to improve their credit scores so that they may obtain credit lines from lenders.

When a lender declines to extend a credit line to a consumer because of the consumer's credit score, the consumer usually has little knowledge as to what actions the consumer may undertake in order to improve the consumer's credit score. Lenders do not assist or encourage consumers to improve their credit scores so that they may obtain credit lines or better credit lines (e.g., credit lines with better terms such as higher credit limits and/or lower finance charges). Therefore, there is a need for methods for extending credits associated with credit ratings to consumers and assist and/or encourage the consumers to improve their credit scores.

### SUMMARY

The present invention is related to methods and systems for extending credit lines associated with credit ratings. In one embodiment, a method for extending credit associated with credit ratings may include receiving at least one credit rating of a person, determining that a credit line having one or more credit terms is not available for the person based on the at least one credit rating of the person, determining one or more actions to be undertaken in order for the person to be extended the credit line having the one or more credit terms, informing the person of the one or more actions to be undertaken, and offering the credit line having the one or more credit terms to the person based on the person completing the one or more actions within a predetermined timeframe.

In another embodiment, a method for extending credit associated with credit ratings may include receiving a first credit rating of a person, determining one or more actions the person may undertake in order to obtain a second credit rating, determining a first credit line for the person based on the first credit rating, determining a second credit line for the person based on the second credit rating, determining a period of time within which the one or more actions must be completed, informing the person of the one or more actions, the first credit line, the second credit line, and the period of time, extending the second credit line to the person, and canceling the second credit line to the person and extending the first credit line to the person if the person fails to complete the one or more actions with the period of time.

In still another embodiment, s method for extending credit associated with credit ratings may include receiving a first credit rating of a person, determining one or more actions the person may undertake in order to obtain a second credit rating, determining a first credit line to the person based on the first credit rating, determining a second credit line to the person based on the second credit rating, determining a period of time within which the one or more actions must be completed, informing the person of the one or more actions, the first credit line, the second credit line, and the period of time, extending the first credit line to the person, and canceling the first credit line to the person and extending the second credit line to the person if the person completes the one or more actions with the period of time.

### BRIEF DESCRIPTION OF THE DRAWINGS

The features, objects, and advantages of the present invention will become more apparent from the detailed description set forth below when taken in conjunction with the drawings, wherein:

FIG. 1 shows a graphical user interface for a system implementing features of extending credit lines associated with credit ratings, the graphical user interface relating to a home screen, according to one embodiment of the present invention;

FIG. 2 shows a graphical user interface for a system implementing features of extending credit lines associated with credit ratings, the graphical user interface relating to a credit offer, according to one embodiment of the present invention;

FIG. 3 shows a graphical user interface for a system implementing features of extending credit lines associated with credit ratings, the graphical user interface relating to a plurality of potential future credit offers, according to one embodiment of the present invention;

FIG. 4 shows a graphical user interface for a system implementing features of extending credit lines associated with credit ratings, the graphical user interface relating to establishment of a particular credit offer, according to one embodiment of the present invention;

FIG. 5 shows a graphical user interface for a system implementing features of extending credit lines associated with credit ratings, the graphical user interface relating to a credit rating goal, according to one embodiment of the present invention;

FIG. 6 shows a graphical user interface for a system implementing features of extending credit lines associated with credit ratings, the graphical user interface relating to an online wallet, according to one embodiment of the present invention; and

FIG. 7 shows a flowchart for a system implementing features of extending credit lines associated with credit ratings, according to one embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

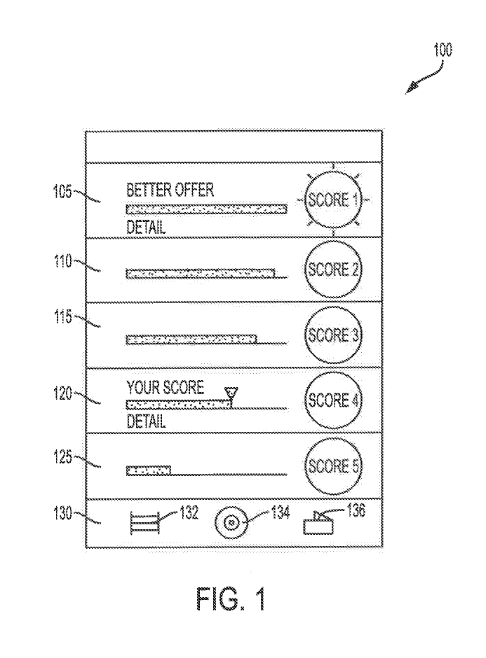

The invention comprises methods and systems for extending credit associated with credit ratings that encourage and/or assist consumers to improve their credit ratings (e.g., credit scores). FIG. 1 illustrates a graphical user interface 100 for a system implementing features of extending credit lines associated with credit ratings. The graphical user interface 100 relates to a home screen (e.g., a dashboard or other home page) for the system, as discussed in greater detail below. The graphical user interface 100 may be configured to be executed and/or displayed upon any of a variety of electronic devices (e.g., desktop computers, laptop computers, mobile or handheld electronic devices, such as smart phones, tablets, PDAs, kiosks, etc.) for executing software code and/or displaying graphics and/or receiving input, transmitting output, and/or making other executions based upon input/output. For example, the graphical user interface 100 may displayed based upon execution of a software application by a processor (e.g., a central processing unit (“CPU”), etc.) in conjunction with a display (e.g., monitor, touchscreen, etc.), memory (e.g., random access memory, etc.) and/or a variety of other components and/or peripherals (e.g., input devices such as a keyboard, mouse, touchscreen or other touch-based device, etc.).

The graphical user interface 100 may include a first portion 105 that may be interfaceable by a user (e.g., clickable or otherwise selectable to load or transfer the user to other graphical user interface screens and/or display additional or different information upon the user interfacing with the first portion 105). For example, additional details may be provided if the user clicks or otherwise selects the first portion 105. The first portion 105 may include information in the form of text and/or graphics that convey to the user a possible financial offer (e.g., extending a line of credit to the user) based upon the user currently having, or obtaining in the future, a particular indicator of credit (e.g., a credit score). For example, the first portion 105 of FIG. 1 indicates to the user that a particular financial offer may be available to the user if the user has or obtains a credit score of “Score1,” such as the score “720.” It may be indicated to the user via the first portion 105 that this offer is deemed an improved or better (e.g., best) offer when compared to other offers listed on the graphical user interface 100. This indication may be provided via placement of the first portion 105 at or near a top of the graphical user interface 100, additional graphical indicators (e.g., an illuminated or glowing icon associated with “Score1,” additional clickable elements already placed within the first portion 105 (e.g., a “detail” part of the first portion 105 that a user may click in order to obtain additional details about the particular financial offer, etc.). Any of a variety of manners may be used to direct attention of the user to this particular financial offer.

Similarly, a second portion 110 of the graphical user interface 100 displays information in the form of text and/or graphics that convey to the user a second possible financial offer based upon an indicator of credit for the user (e.g., the user having or obtaining a credit score of “Score2,” such as “700,” with a credit rating agency, a PICC score, etc.). Likewise, a third portion 115 of the graphical user interface 100 displays information in the form of text and/or araphics that convey to the user a third possible financial offer based upon an indicator of credit for the user (ex., the user having or obtaining a credit score of “Score3,” such as “680,” with a credit rating agency, a FICO score, etc). Similarly, a fourth portion 120 of the graphical user interface 100 displays information in the form of text and/or graphics that convey to the user a fourth possible financial offer based upon an indicator of credit for the user (e.g., the user having or obtaining a credit score of “Score4,” such as “620,” with a credit rating agency, a FICO score, etc.). Finally, a fifth portion 125 of the graphical user interface 100 displays information in the form of text and/or graphics that convey to the user a fifth possible financial offer based upon an indicator of credit for the user (e.g., the user having or obtaining a credit score of “Score5,” such as “580,” with a credit rating agency, a FICO score, etc.).

As indicated, the user may click or otherwise select one or more of the first portion, second portion, third portion, fourth portion, or fifth portion (105, 110, 115, 120, 125) in order to get additional details about their score and/or the financial offer fourth portion 120 is illustrated as having been selected by the user. Greater or fewer financial offers may be provided in alternative embodiments. Although the embodiment shown illustrates separate offers being shown for different scores, separate offers may he shown for a same score. Some or all these indicators of credit may be received by the system implementing the graphical user interface 100 prior to display of the graphical user interface 100 to the user. Moreover, the indicators of credit may come from a single or from multiple different credit raters or credit rating institutions. Similarly, in various embodiments, the offers shown to the user may come from a single financial institution or may come from multiple different financial institutions.

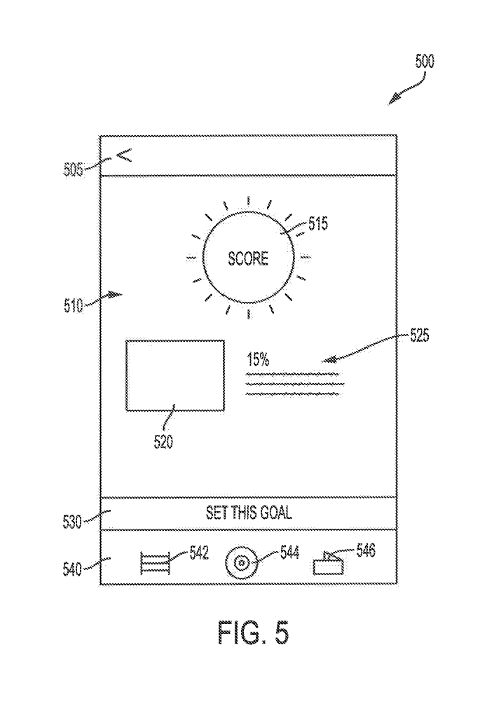

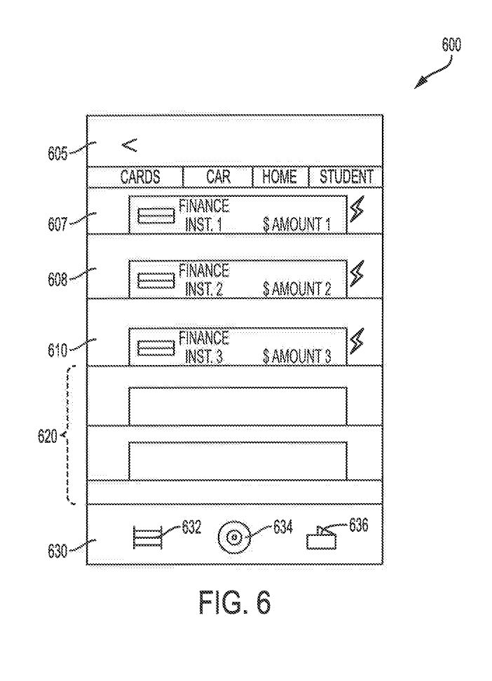

A sixth portion 130 of the graphical user interface 100 may include selectable elements disposed within, for example, to allow a user to navigate directly to particular screens and/or features of the system implementing the graphical user interface 100. For example, a “Dashboard” icon or other display element 132 may be selectable by a user to return to a home screen graphical user interface of the system (e.g., may “refresh” the graphical user interface 100). In another example, a “Goals” icon or other display element 134 may be selectable by a user to navigate the user to credit-related goals graphical user interfaces of the system, for example, as discussed in greater detail for FIG. 5. In still another example, a “Wallet” icon or other display element 136 may be selectable by a user to navigate the user to wallet or banking graphical user interfaces of the system, for example, as discussed in greater detail for FIG. 6. In an alternative embodiment, any of a variety of possible layouts, display portions, and/or display elements may be used for the graphical user interface 100.

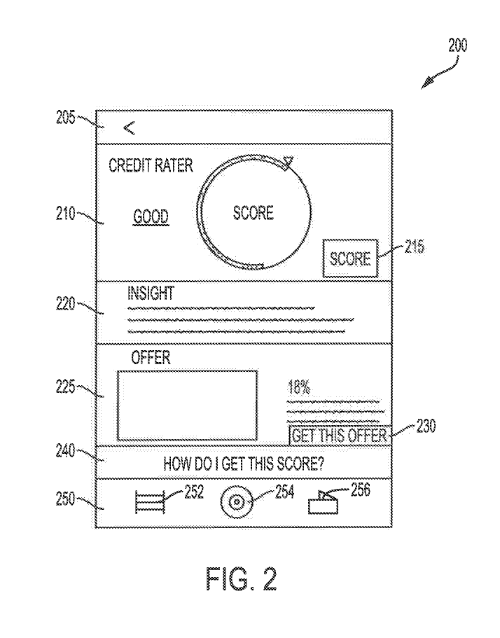

FIG. 2 illustrates a graphical user interface 200 for a system implementing features of extending credit lines associated with credit ratings, the graphical user interface relating to a credit offer currently available to a user. The system may include features that are the same as or similar to those previously discussed. Moreover, the graphical user interface 200 may be displayed to a user based upon the user's interaction with other graphical user interface screens (e.g., graphical user interface 200 may he displayed based upon a user's interaction with one or more portions of the graphical user interface 100, such as fourth portion 120, as previously discussed for FIG. 1). Various portions of the graphical user interface 200 may be interfaceable by a user, the same or similar to previous discussions.

A first portion 205 of the graphical user interface 200 may allow a user to navigate back to a previous graphical user interface and/or portion of the system (e.g., the interface or portion of the system immediately preceding the display of graphical user interface 200) upon selection by the user. A second portion 210 of the graphical user interface 200 may display a credit indicator (e.g., a credit score from one or more credit agencies or credit raters) corresponding to the user. In one embodiment, as shown, the credit rater which generated and/or supplied the credit score may also be displayed within the second portion 210 so that the user is aware from where or to which credit rater the credit indicator came from. The second portion 210 may also include an indicator to the user of whether the credit score is favorable or not, for example as indicated by the “good” text illustrated.

A display element 215 (e.g., text, graphics, etc.) may be selectable by the user to get additional information relating to the user's credit indicator, for example, a comparison of the user's particular credit indicator with credit indicator(s) corresponding to other individuals and/or other timeframes. For example, in one embodiment, a user may select the display element 215 and the system will determine and/or display to the user averages (e.g., national averages, peer group averages, etc.) of the credit indicator so that the user may see where they fall or rank when compared against such other people or groups. In another embodiment, a user may select the display element 215 and the system will determine and/or display to the user a prior credit indicator corresponding to the user (e.g., a credit indicator from 1 month ago, 12 months ago, etc.) so that a user may compare how their credit score changed with time. Such comparative credit indicator information may aid in having a motivational effect upon the user to maintain or increase the credit indicator.

A third portion 220 of the graphical user interface 200 may provide other insights into the user's credit indicator (e.g., why the indication of credit should matter to the user, how or why the credit indicator or score dropped or raised in value, factors that are associated with a change in credit indicator, etc.) Likewise, a fourth portion 240 may provide information to the user on what steps or other influencers may be performed in order to obtain a more desirably credit indicator (e.g., raise the user's credit score) and/or influencers that may prevent a user from obtaining a score (e.g., what causes a credit score to decrease).

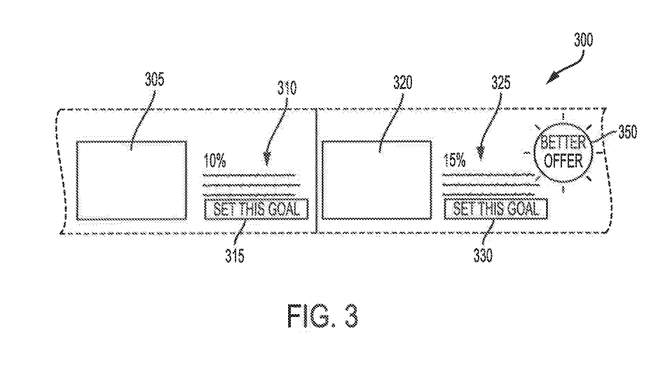

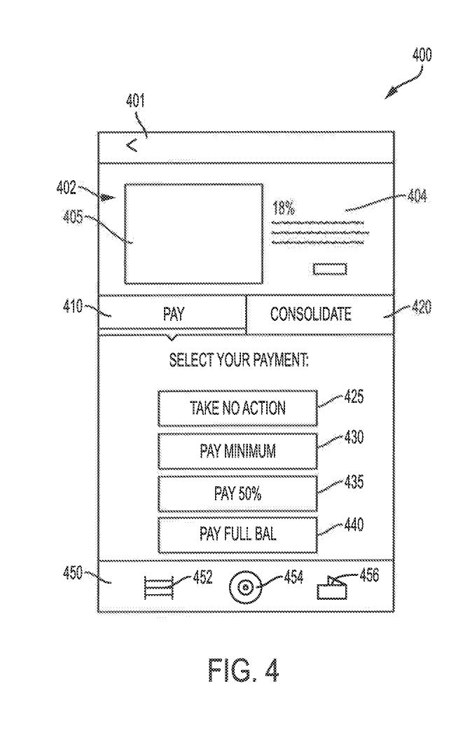

A fifth portion 225 of the graphical user interface 200 provides information about an offer to the user (e.g., an offer for extension of credit to the user) based upon the user's credit indicator (e.g., the system may determine an appropriate offer to the user based upon the user's credit indicator as shown in the second portion 210 and subsequently display such offer to the user). For example, this information about an offer may correspond to an offer that was shown and/or selected by the user from a previously graphical user interface (e.g., via selection of the fourth portion 120 of graphical user interface 100 shown on FIG. 1). Accordingly, a display element 230 allows the user to select or otherwise interface with the display element 230 in order for the user to seek attainment of the offer determined and made available by the system, as discussed in greater detail below, for example, in. FIG. 4. The filth portion 225 may include text (e.g., interest rate or percentage, etc.), graphics (e.g., an image showing the financial institution that is making the offer available to the user, etc.). One or more other aspects of the fifth portion 225 may be selectable by the user in order to see additional offers that may be made available to the user, provided that the user obtains a changed credit indicator, for example, as discussed further for FIG. 3.

A sixth portion 250 of the graphical user interface 200 may include selectable elements disposed within, for example, to allow a user to navigate directly to particular screens and/or features of the system implementing the graphical user interface 200. For example, a “Dashboard” icon or other display element 252 may be selectable by a user to return to a home screen graphical user interface of the system (e.g., graphical user interface 100). In another example, a “Goals” icon or other display element 254 may be selectable by a user to navigate the user to credit-related goals graphical user interfaces of the system, for example, as discussed in greater detail for FIG. 5. In still another example, a “Wallet” icon or other display element 256 may be selectable by a user to navigate the user to wallet or banking graphical user interfaces of the system, for example, as discussed in greater detail tbr FIG. 6. In an alternative embodiment, any of a variety of possible layouts, display portions, and/or display elements may be used for the graphical user interface 200.

FIG. 3 illustrates a graphical user interface 300 for a system implementing features of extending credit lines associated with credit ratings, the graphical user interface relating to a plurality of potential credit offers. The system may include features that are the same as or similar to those previously discussed. Moreover, the graphical user interface 300 may be displayed to a user based upon the user's interaction with other graphical user interface screens (e.g., graphical user interface 300 may be displayed based upon a user's interaction with one or more portions of the graphical user interface 200, such as fifth portion 225, as previously discussed for FIG. 2). Various portions of the graphical user interface 300 may be interfaceable by a user, the same or similar to previous discussions.

It may be beneficial to a user if a credit indicator or credit score received and/or determined for the user is insufficient to qualify the user for a particular credit line from a lender, the system may inform the user what offers might be available to the user if the user were to qualify for them. A first portion 305 of the graphical user interface 300 may indicate or display a lender (e.g., name, graphic, etc.) and certain offer terms MO that the lender would be willing to make based upon the user qualifying for such offer. For example, an offer may be displayed to a user (e.g., via fifth portion 225 of graphical user interface 200) based upon the user's current eligibility due to credit worthiness, while the offer terms 310 in the first portion 305 of graphical user interface 300 may include more desirable terms for the user. In order to obtain an offer with the offer terms 310, the system indicates to the user what steps and/or credit indicator must be performed or achieved in order to qualify. The user may select a display element 315 in order to set the steps and/or credit indicator as a goal for achievement in order to be eligible. The goal may then be displayed and/or tracked for the user, for example, as discussed in further detail for FIG. 5.

The graphical user interface 300 may also include a second portion 320 that indicates or displays a second lender (e.g., name, graphic, etc.) and certain offer terms 325 that the lender would be willing to make based upon the user qualifying for such offer. In order to obtain an offer with the offer terms 325, the system indicates to the user what steps and/or credit indicator must be performed or achieved in order to qualify. The user may select a display element 330 in order to set the steps and/or credit indicator as a goal for achievement in order to be eligible. The goal may then be displayed and/or tracked for the user, for example, as discussed in further detail for FIG. 5. Any of a number of different lenders and/or different offers or offer terms for a given lender may be provided in alternative embodiments.

Certain embodiments of the system may perform an analysis or algorithm of one or more of the offers (e.g., offer terms 310, 325, etc.) and display a “best offer” or “better offer” indicator 350 adjacent or associated with one or more of the offers displayed. In one embodiment, this analysis may be a determination based upon total payment the user would pay over the lifetime of the credit offer compared with the total payment the user would pay over the lifetime of the credit for other offers. Thus, if one lender and/or offer results in a user paying the lender a total amount that is less than one and/or more of the other offers, the indicator 350 may be associated with such lender and/or offer. A user may he able to easily distinguish the most desirable offers of credit. In other embodiments, this analysis, determination, or comparison between offers may be based on additional and/or different criteria (e.g., life on loan, down payment required, interest rate, etc.). In certain embodiments, the user may be able to choose which factor and/or factors are most desirable to them so that the system may appropriately perform the determination for display of the indicator 350.

FIG, 4 illustrates a graphical user interface 400 for a system implementing features of extending credit lines associated with credit ratings, the graphical user interface relating to establishment of a particular credit offer for a user. The system may include features that are the same as or similar to those previously discussed. Moreover, the graphical user interface 400 may be displayed to a user based upon the user's interaction with other graphical user interface screens (e.g., graphical user interface 400 may be displayed based upon a user's interaction with one or more portions of the graphical user interface 200, such as the display element 230, as previously discussed for FIG. 2). Various portions of the graphical user interface 400 may be interfaceable by a user, the same or similar to previous discussions.

A first portion 401 of the graphical user interface 400 may allow a user to navigate back to a previous graphical user interface and/or portion of the system (e.g., the interface or portion of the system immediately preceding the display of graphical user interface 400) upon selection by the user. A second portion 402 of the graphical user interface 400 includes a graphic, icon, or other text corresponding to the particular lender 405 and associated offer terms 404 associated with the credit offer chosen by the user. Thus, for example, if a particular credit offer is made to the user and the user accepts or opts to proceed with obtaining such offer, the second portion 402 graphical user interface 400 includes such details relating to the offer being obtained.

Selecting or having active a third portion 410 of the graphical user interface may provide additional interfaceable elements (425, 430, 435, 440) on the graphical user interface 400. For example, the third portion 410 may constitute a clickable or selectable tab relating to payment options for the user to take with respect to the credit offer that has been chosen by the user. In the embodiment shown in FIG. 4, a first interfaceable element 425 allows the user to select the first interfaceable element 425 to take no payment action at this time on the chosen credit offer, a second interfaceable element 430 allows the user to select the second interfaceable element 430 to pay a minimum amount corresponding to the balance on the chosen credit offer, a third interfaceable element 435 allows the user to select the third interfaceable element 435 to pay 50% of the balance on the chosen credit offer, and a tburth interfaceable element 440 allows the user to select the fourth interfaceable element 440 to pay the full balance on the chosen credit offer. Thus, upon selecting and obtaining a desired credit offer, as previously discussed, the user may manage the obtained credit via payments made via the third portion 410 (e.g., payment tab). A fourth portion 420 of the graphical user interface may provide additional, fewer, and/or alternative options (e.g., interfaceable elements) for a user (e.g., credit or loan consolidation options) if the offer chosen by the user, as previously discussed, relates to a plurality of loans being consolidated. Alternative tabs and/or portions may be used in alternative embodiments.

A fifth portion 450 of the graphical user interface 400 may include selectable elements disposed within, for example, to allow a user to navigate directly to particular screens and/or features of the system implementing the graphical user interface 400. For example, a “Dashboard” icon or other display element 452 may be selectable by a user to return to a home screen graphical user interface of the system (e.g., graphical user interface 100). In another example, a “Goals” icon or other display element 454 may be selectable by a user to navigate the user to credit-related goals graphical user interfaces of the system, for example, as discussed in greater detail tbr FIG. 5. In still another example, a “Wallet” icon or other display element 456 may be selectable by a user to navigate the user to wallet or banking graphical user interfaces of the system, for example, as discussed in greater detail for FIG. 6. In an alternative embodiment, any of a variety of possible layouts, display portions, and/or display elements may be used for the graphical user interface 400.

FIG. 5 illustrates a graphical user interface 500 for a system implementing features of extending credit lines associated with credit ratings, the graphical user interface 500 relating to a credit indicator or credit rating goal. The system may include features that are the same as or similar to those previously discussed. Moreover, the graphical user interface 500 may be displayed to a user based upon the user's interaction with other graphical user interface screens (e.g., graphical user interface 500 may be displayed based upon a user's interaction with one or more portions of the graphical user interface 300, such as the display elements 315 and/or 330, as previously discussed for FIG. 3 or for other display elements previously discussed, such as display element 134, 254, and/or 454). Various portions of the graphical user interface 500 may be interfaceable by a user, the same or similar to previous discussions.

A first portion 505 of the graphical user interface 500 may allow a user to navigate back to a previous graphical user interface and/or portion of the system (e.g., the interface or portion of the system immediately preceding the display of graphical user interface 500) upon selection by the user. A second portion MO of the graphical user interface 500 includes a goal 515 (e.g., a credit rating or score goal) that has been established by or for the user (e.g., via user interaction with the display element 315 that corresponds to a credit rating required for offer terms 310). One or more of the offer terms that are available if the user were to have the goal may be displayed as goal offer terms 525 corresponding to a particular goal lender 520. For example, as specifically illustrated in the embodiment of FIG. 5, a credit rating goal 515 (e.g., credit score such as “720”) is shown and offer terms 525 from a lender 520 would he available for an offer (e.g., a line of credit) to the user if the user were to achieve and/or maintain the credit rating goal 515.

A third portion 530 may allow for the user to replace a current goal that has been established in the system with a new goal. For example, if a user initially had chosen or established a goal of “700” for a credit rating with associated offer terms, but the user later determines they would prefer to establish a goal of “720” for a credit rating with its associated offer terms, in place of the ones for the “700” credit rating, the user may interface with the third portion 530 in order to accordingly update their preference. In certain embodiments, multiple goals may be established and/or maintained concurrently for a user.

A fourth portion 540 of the graphical user interface 500 may include selectable elements disposed within, for example, to allow a user to navigate directly to particular screens and/or features of the system implementing the graphical user interface 500. For example, a “Dashboard” icon or other display element 542 may be selectable by a user to return to a home screen graphical user interface of the system (e.g., graphical user interface 100). In another example, a “Goals” icon or other display element 544 may be selectable by a user to “refresh” credit-related goals graphical user interfaces of the system, for example, graphical user interface 500. In still another example, a “Wallet” icon or other display element 546 may be selectable by a user to navigate the user to wallet or banking graphical user interfaces of the system, for example, as discussed in greater detail for FIG. 6. In an alternative embodiment, any of a variety of possible layouts, display portions, and/or display elements may be used for the graphical user interface 500.

FIG. 6 illustrates a graphical user interface 600 for a system implementing features of extending credit lines associated with credit ratings, the graphical user interface 600 relating to an online wallet. The system may include features that are the same as or similar to those previously discussed. Moreover, the graphical user interface 600 may be displayed to a user based upon the user's interaction with other graphical user interface screens (e.g., graphical user interface 600 may he displayed based upon a user's interaction with one or more portions of the graphical user interface 400, such as the interfaceable elements 430, 435, and/or 440, as previously discussed for FIG. 4 or for other display elements previously discussed, such as display element 136, 256, 456, and/or 556). Various portions of the graphical user interface 600 may be interfaceable by a user, the same or similar to previous discussions.

A first portion 605 of the graphical user interface 600 may allow a user to navigate back to a previous graphical user interface and/or portion of the system (e.g., the interface or portion of the system immediately preceding the display of graphical user interface 600) upon selection by the user. Additional portions (607, 608, 610, 620) include information associated with the user, such as financial information, corresponding to one or more financial institutions. For example, a second portion 607 includes an amount or balance that the user has with a first financial institution. Similarly, third portion 608 includes an amount or balance that the user has with a second financial institution. Likewise, fourth portion 610 includes an amount or balance that the user has with a third financial institution. Any number of financial institutions and/or accounts within a same financial institution may be shown on the graphical user interface, as indicated by a fifth portion 620 that may exist and/or be scrolled through depending upon the number of accounts setup by the user as part of the online wallet. Information may be received by the system (e.g., daily, in real-time, etc.) from the above financial instutions in order for it to be displayed on the graphical user interface 600.

In certain embodiments, the graphical user interface 600 may separate information into categories (e.g., “cards,” “car,” “home,” “student,” etc.) for example, to provide easier display of information to the user whereby the user may click on one of the categories in order to see account or wallet information associated only with such category. For example, the user may be able to setup his or her own categories and correspondingly associate specific accounts with those categories and/or certain categories may be established by default and/or certain accounts automatically associated with certain categories. The user may use the funds established in one or more of these accounts included in the wallet described for the graphical user interface 600 for mere informative purposes (e.g., to have an easy and/or centralized location via the software application by which to view all or some of their account balances or other information at a glance) and/or for payment purposes (e.g., the system may process a payment made by the user from one or more of the selected accounts by the user in the online wallet). For example, if the user had established a particular credit offer from a lender, the user may be able to process payment for that credit via the accounts in their online wallet.

A sixth portion 630 of the graphical user interface 600 may include selectable elements disposed within, for example, to allow a user to navigate directly to particular screens and/or features of the system implementing the graphical user interface 600. For example, a “Dashboard” icon or other display element 632 may be selectable by a user to return to a home screen graphical user interface of the system (e.g., graphical user interface 100). In another example, a “Goals” icon or other display element 634 may be selectable by a user to navigate the user to a credit-related goals graphical user interfaces of the system, for example, graphical user interface 500, as discussed in greater detail for FIG. 5. In still another example, a “Wallet” icon or other display element 546 may be selectable by a user to “refresh” one or more accounts and/or associated information in a wallet graphical user interface of the system, for example, graphical user interface 600. In an alternative embodiment, any of a variety of possible layouts, display portions, and/or display elements may be used for the graphical user interface 600.

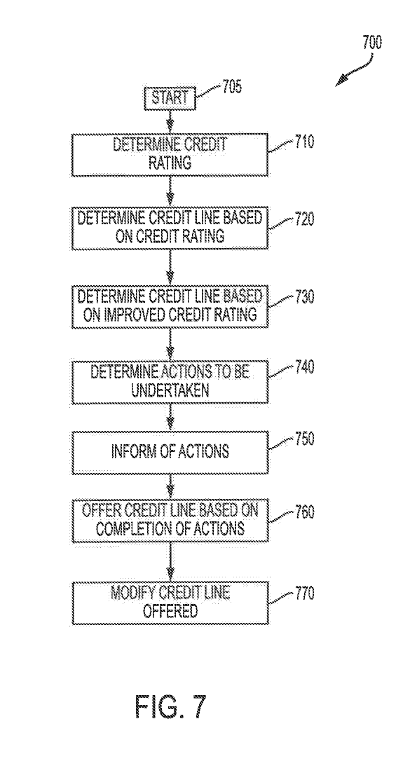

Although FIGS. 1-6 disclose certain features in the context of a system for implementing extension of credit lines associated with credit ratings according to various graphical user interfaces, any of a variety of possible configurations and/or interfaces may be used in alternative embodiments to yield the operation of one or more of the features disclosed. For example, FIG. 7 shows a flowchart 700 for a system implementing features of extending credit lines associated with credit ratings, according to one embodiment of the present invention. The system may include features that are the same as or similar to those previously discussed. As shown, operation begins at step 705. The may occur if a person signs on to the system (e.g., via a website, such as on the Internet) and/or via speaking with an individual who interfaces with the system on behalf of the person (e.g., a lending or other institution or individual with access to the system and/or information required for the following operation).

At step 710, a credit rating is determined for the person. As previously discussed, this may be a rating of the person's credit worthiness by an agency or institution who determines ratings for an individual's credit histoid. At step 720, a credit line having one or more particular credit terms (e.g., term length, credit limit, finance rate charge, down payment, etc.) is determined based on the credit rating determined at step 710. At step 730, a second credit line having one or more particular credit terms (e.g., term length, credit limit, finance rate charge, down payment, etc.) are different from the credit line having one or more particular credit terms at step 720 is determined based upon a credit rating that is different (e.g., improved) from the credit rating determined at step 710. In some embodiments, multiple credit lines having their particular credit terms may be determined at steps 720 and/or 730 such that they may be chosen or selected amongst, for example, based upon preferences of the person.

At step 740, one or more actions are determined in order to improve the credit rating determined in step 710 to the credit rating used for the determination of the credit line at step 730. Any of a variety of possible actions may be determined (e.g., increasing the person's ability to repay a loan, increasing the person's savings to a certain amount, increasing the person's income, etc.).

For example, if the credit rating at step 710 is “650,” but the credit line at step 730 is based upon the person having a “700+” credit rating, one or more actions may be determined for the person in order to raise their credit rating from “650” to at least “700.” At step 750, these one or more actions are disclosed to the person (e.g., by display upon a display device, for example using a graphical user interface as previously discussed, through communication through a third party, such as a lending institution, etc.).

At step 760, a line of credit is offered to the person based on the completion of the one or more actions, for example, within a predetermined period of time. For example, the initial line of credit that is currently available to the person based on their current credit score may be offered to the person, having a credit term that allows the line of credit to be modified and/or swapped to a different line of credit should the person complete one or more actions within the predetermined period of time. In another example, the line of credit that would be available to the person if the person had a higher credit score may be immediately offered to the person and having a credit term that allows the line of credit to be downgraded or swapped to a different (lower grade) line of credit should the person not complete all the requisite actions within the predetermined time period. In certain embodiments, the time period may be extendible, for example, based upon the person completing certain of the actions required, and/or based upon other activity. At step 770, as mentioned above, the line of credit offered to the person may be modified (e.g., upgraded, downgraded, replaced, etc.) based upon completion or non-completion of the specified one or more actions. As previously discussed, payment receipt/processing may also be taken after a line of credit has been established for the person.

Thus, in one possible embodiment using the features and/or operation previously discussed throughout FIGS. 1-7, a method of the present invention may include receiving one or more credit scores of a person. If the credit scores are insufficient to qualify the person for a credit line from a lender, then the lender informs the person what actions the person needs to take in order to improve the credit scores and obtain a credit line from the lender. The actions may include increasing the person's ability to repay a loan, increasing the person's savings to a certain amount, and/or increasing the person's income. Once the person completes the actions, the lender may then extend a credit line to the person.

The lender may inform the person of the terms of the credit line, such as credit limit and/or finance charge on unpaid balance, before the person begins to endeavor to complete the actions. Alternatively, the lender may elect to surprise the person by informing the person of the terms after the person complete one or more (e.g., all) of the actions. The person completing the action(s) may be pleasantly surprised by the terms (such as a higher than expected credit limit). Therefore, the person may be more encouraged to complete the action(s) in order to improve his/her credit scores.

Similarly, in another example of an embodiment using the features and/or operation previously discussed throughout FIGS. 1-7, the lender may receive a first credit score of a person (for example, a FICO score 550), then determines the one or more action(s) the person needs or should undertake in order to improve the person's credit rating to a second credit score (for example, a FICO score 600). The lender may also set a pre-determined time period within which the person must complete the action(s) (for example, 10 months). The lender determines a first credit line based on the first credit score (for example, a $1,000 credit limit with 18% finance charge on unpaid balance), and a second credit line based on the second credit score (for example, a $2,000 credit limit with 15% finance charge on unpaid balance). The lender then inform the person of the first credit line, the second credit line, the pre-determined time period, and/or the action(s) the persons needs to take within the pre-determined time period.

The lender may opt to extend the second credit line to the person on the condition that the person shall complete the action(s) within the pre-determined time period. If the person fails to complete the action(s) within the pre-determined time period, then the lender may cancel the second credit line and instead extend the first credit line to the person.

In addition, similar to the above and in another example of an embodiment using the features and/or operation previously discussed throughout FIGS. 1-7, instead of extending the second credit line first, the lender may extend the first credit line to the person initially with the condition that the first credit line will be upgraded to the second credit line if the person complete the action(s) within the per-determined time period.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes, which come within the meaning and range of equivalency of the claims, are to he embraced within their scope. Skilled artisans may implement the described functionality in varying ways for each particular application, but such implementation decisions should not be interpreted as causing a departure from the scope of the disclosed apparatus and methods. The steps of the method may also be performed in an alternate order from those provided in the examples.

1. A method for extending credit associated with credit ratings comprising:
receiving at least one credit rating of a person;
determining that a credit line having one or more credit terms is not available fix the person based on the at least one credit rating of the person;
determining one or more actions to be undertaken in order for the person to be extended the credit line having the one or more credit terms;
informing the person of the one or more actions to be undertaken; and
offering the credit line having the one or more credit terms to the person based on the person completing the one or more actions within a predetermined timeframe.

2. The method of claim 1 wherein one or more credit terms includes a particular credit limit.

3. The method of claim 1 wherein the one or more credit terms includes a particular a finance rate charge on an unpaid balance.

4. The method of claim 1 wherein one or more terms associated with the credit line are disclosed to the person before the one or more actions are undertaken by the person.

5. The method claim 1 wherein the one or more terms are not disclosed to the person until after the person completes at least one of the one or more actions.

6. The method of claim 1 wherein the credit line having the one or more credit terms is offered to the person before the person completes the one or more actions to be undertaken.

7. The method of claim 6 wherein the credit line having or more credit terms is downgraded to a credit line having different one or more credit terms if the person does not complete the one or more actions within the predetermined timeframe.

8. The method of Claim 1 further comprising:
determining that a second credit line having one or more credit terms is not available for the person based on the at least one credit rating of the person; and
receiving input that the credit line is chosen instead of the second credit line.

9. A method for extending credit associated with credit ratings comprising:
receiving a first credit rating of a person;
determining one or more actions the person may undertake in order to obtain a second credit rating;
determining a first credit line for the person based on the first credit rating;
determining a second credit line for the person based on the second credit rating;
determining a period of time within which the one or more actions must be completed;
informing the person of the one or more actions, the first credit line, the second credit line, and the period of time;
extending the second credit line to the person; and
canceling the second credit line to the person and extending the first credit line to the person if the person fails to complete the one or more actions with the period of tim.

10. The method of claim 9 wherein the second credit rating is higher than the first credit rating.

11. The method of claim 9 further comprising extending the period of time within which the one or more actions must be completed based upon completion of at least one of the one or more actions.

12. The method of claim 9 further comprising determining a third credit line for the person based on the second credit rating.

13. The method of claim 12 further comprising receiving a selection from the person of the second credit line over the third credit line.

14. The method of claim 9 further comprising processing a payment from the person corresponding to the first credit line or the second credit line.

15. A method for extending credit associated with credit ratings comprising:
receiving a first credit rating of a person;
determining one or more actions the person may undertake in order to obtain a second credit rating;
determining a first credit line to the person based on the first credit rating;
determining a second credit line to the person based on the second credit rating;
determining a period of time within which the one or more actions must be completed;
informing the person of the one or more actions, the first credit line, the second credit line, and the period of time;
extending the first credit line to the person; and
canceling the first credit line to the person and extending the second credit line to the person if the person completes the one or more actions with the period of time.

16. The method of claim 15 wherein the second credit rating is higher than the first credit rating.

17. The method of claim 15 further comprising extending the period of time within which the one or more actions must be completed based upon completion of at least one of the one or more actions.

18. The method of claim 15 further comprising determining a third credit line for the person based on the second credit rating.

19. The method of claim 18 further comprising receiving a selection from the person of the second credit line over the third credit line.

20. The method of claim 15 further comprising processing a payment from the person corresponding to the first credit line or the second credit line.
